(19) United States
(12) Patent Application Publication
(10) Pub. No.: US 2023/0304115 A1
(43) Pub. Date: Sep. 28, 2023

(54) METHOD FOR PRODUCING AN ELECTRIC STRIP

(71) Applicant: NNTECH GMBH, Linz (AT)

(72) Inventors: Christian Dorfbauer, Linz (AT); Marius Kreuzeder, St. Pölten (AT)

(73) Assignee: NanoNeal Technologies GmbH, Linz (AT)

(21) Appl. No.: 18/022,078

(22) PCT Filed: Aug. 18, 2021
(86) PCT No.: PCT/AT2021/060288

§ 371 Date: Feb. 17, 2023

(30) Foreign Application Priority Data
Aug. 20, 2020 (AT) A50703/2020

(51) Int. Cl. C21D 8/12; C22C 38/02; C22C 38/06; C22C 38/04; C22C 38/00; C21D 9/52

(52) U.S. Cl. CPC C21D 8/1233; C21D 8/1272; C21D 8/1283; C21D 9/52; C22C 38/002; C22C 38/02; C22C 38/04; C22C 38/06

(57) ABSTRACT

A method for processing a siliceous may include providing the steel sheet in a strip-type state, conducting a heat treatment for producing a non-grain-oriented electric steel strip, and moving the steel sheet through an annealing plant with a heating region, a holding region and a cooling region in a continuous process during the heat treatment. The steel sheet may be moved in the annealing plant in a vertical conveying direction. The steel sheet may be moved in the annealing plant from a furnace entry region arranged in a lower end region of the annealing plant via deflection rollers arranged in an upper end region of the annealing plant to a furnace exit region arranged in the lower end region of the annealing plant. The heating region and the holding region may extend between the furnace entry region and the deflection rollers.

### CROSS-REFERENCE TO RELATED APPLICATIONS

This application claims priority to International Patent Application No. PCT/AT2021/060288, filed on Aug. 18, 2021, and Austrian Patent Application No. A50703/2020, filed on Aug. 20, 2020, the contents of both of which are hereby incorporated by reference in their entirety.

### TECHNICAL FIELD

The disclosure relates to a method for processing a siliceous, cold-rolled steel sheet with a heat treatment for producing a non-grain-oriented electric steel strip.

### BACKGROUND

Steel sheets made of iron-silicon alloys having a high silicon content, in particular having a silicon content of more than 1.5 wt.%, are of great interest for a number of electrotechnical and/or electromagnetic applications. Such steel sheets, usually referred to as electrical sheets or electric steel strips, have a higher saturation magnetization combined with higher electrical resistance values, and thus offer the advantage of fewer magnetic losses, particularly in applications at higher frequencies.

In order to produce such electrical sheets, after smelting the steel alloys, the melts are cast into so-called slabs. In a hot-rolling process, so-called hot-rolled strips are produced from this primary material. For this purpose, in case the primary material cools down in the meantime, the surfaces need to be reheated and descaled in order to remove remaining oxide layers. This is usually done by means of a chemical surface treatment carried out as a deoxidizing operation. The hot-rolled strips obtained are then rolled to form a cold-rolled strip. Finally, a heat treatment of the strips is carried out in annealing furnaces, wherein the formation of a crystalline structure favoring the desired properties is achieved by means of the annealing process.

In the intermediate stages of processing such steel strips into electrical sheets, the strips are wound up into rolls, so-called coils. In order to be able to carry out the production process in a continuous operation, intermediate stations, in which the coils are unwound, and the ends of the coils delivered successively are welded to one another, are provided in the production plants provided therefor. On the other hand, it is provided that, at the exit of the production plants, the continuous strips are cut and re-wound into coils.

### SUMMARY

The object of the disclosure to create a method for processing a siliceous, cold-rolled steel sheet, which enables the production of a non-grain-oriented electric steel strip with improved magnetic properties as well as with a significantly improved surface quality.

This object of the disclosure is achieved by a method for processing a siliceous, cold-rolled steel sheet with a heat treatment for producing a non-grain-oriented electric steel strip, wherein the steel sheet contains a part by weight of silicon of 1.5 % to 6 %, and wherein the steel sheet is provided in a strip-type state and is moved through an annealing plant with a heating region, a holding region and a cooling region in a continuous process during the heat treatment, wherein the steel sheet is moved in the annealing plant in a vertical main conveying direction.

According to a preferred approach, it is provided that the steel sheet is moved in the annealing plant, from a furnace entry region, which is arranged in a lower end region of the annealing plant, via deflection rollers, which are arranged in an upper end region of the annealing plant, to a furnace exit region, which is arranged in the lower end region of the annealing plant.

The approach, in which the heating region and the holding region extend between the furnace entry region and the deflection rollers, is also advantageous.

In a preferred approach, it is provided that during a heating phase, the steel sheet is heated in the heating region to a maximum temperature in a range of 920° C. to 1150° C., preferably of 950° C. to 1100° C.

It is particularly advantageous if the heating of the steel sheet is carried out during the heating phase at a heating rate of 100° C./s to 1000° C./s in a first section and at a heating rate of 3° C./s to 50° C./s in a second section.

According to a preferred approach, in the holding region, the steel sheet is held at the maximum temperature in a holding phase with a duration of 5 s to 45 s, preferably with a duration of 10 s to 30 s.

An advancement of this approach, in which, following the holding phase, the steel sheet is cooled to a first intermediate temperature of 200° C. to 1050° C., preferably 400° C. to 900° C., between the holding region and the deflection rollers, wherein it is cooled at a cooling rate of 3° C./s to 30° C./s, preferably at a cooling rate of 5° C./s to 15° C./s, is advantageous.

A preferred heat treatment of the steel sheet provides that, following the deflection rollers, the steel sheet is cooled down in a first section from the first intermediate temperature to a second intermediate temperature in a range of 200° C. to 1050° C., preferably 400° C. to 900° C., wherein the cooling is carried out at a cooling rate of 3° C./s to 30° C./s, preferably at a cooling rate of 5° C./s to 15° C./s.

Moreover, it is advantageous if subsequently, in a second section, the steel sheet is further cooled down from the second intermediate temperature during the movement towards the furnace exit region, wherein the cooling is carried out at a cooling rate of 3° C./s to 60° C./s, preferably at a cooling rate of 15° C./s to 35° C./s.

The approach, according to which an inert gas atmosphere consisting mainly of hydrogen and having a hydrogen content of more than 99 % (vol%) is provided in the annealing plant, hast the advantage that a further formation of oxide layers on the surface can be prevented.

It proves particularly advantageous if water vapor having a very low proportion, in particular having a proportion corresponding with a dew point of -70° C. to -45° C., is contained in the inert gas atmosphere.

The method is particularly suitable for steel sheet having a thickness value of 0.05 mm to 0.5 mm.

Applying this method is suitable in particular for treating electric steel strips made from alloyed steels with alloying components in weight proportions of Si: 1.5% to 6%, preferably 2% to 4%, Al: 0.05% to 2%, C: < 0.01%, preferably < 0.005%, Mn: 0.05% to 5%, P: 0.01% to 0.2%, S: < 0.01%, preferably < 0.005%, and N: < 0.01%, preferably < 0.005%.

For the purpose of better understanding of the invention, it will be elucidated in more detail by means of the figures below.

### BRIEF DESCRIPTION OF THE DRAWINGS

These show in a respectively very simplified schematic representation:

FIG. 1 shows a device for processing a siliceous, cold-rolled steel sheet;

FIG. 2 shows an annealing plant for heat treatment of the steel sheet according to FIG. 1;

FIG. 3 shows a diagram of the temperature progression of the steel sheet during the heat treatment;

FIG. 4 shows an alternative exemplary embodiment of the annealing plant for heat treatment of the steel sheet; and

FIG. 5 shows a further alternative exemplary embodiment of the annealing plant.

### DETAILED DESCRIPTION

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

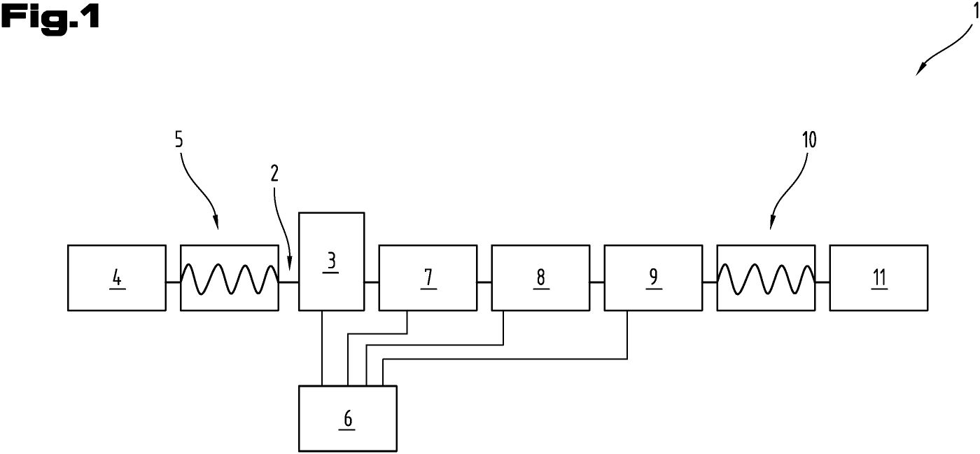

FIG. 1 shows a device 1 in the form of a production line for processing a siliceous, cold-rolled steel sheet 2 with a heat treatment for producing a non-grain-oriented electric steel strip. In this process, the steel sheet 2, which is subjected to a heat treatment in the device 1, is a cold-rolled steel strip having a thickness in a range of 0.05 mm to 0.5 mm. In the processing method, the steel sheet 2 is provided in a strip-type state and is moved through successively arranged stations of the production line in a continuous process during the processing. As the primary processing station of the device 1, it comprises an annealing plant 3 for heat treatment of the steel sheet 2.

On the entry side, the device 1 comprises a preparation station 4 for provided the steel sheet 2 fed as an endless belt. The preparation station 4 shown in FIG. 1 as only one component represents multiple individual processing stations and/or preparation activities such as the unwinding of the cold-rolled steel sheet 2 from corresponding coils, the welding together of the successive ends of multiple coils to form the endless belt, and a preparatory cleaning and/or degreasing of the surfaces. The subsequently arranged strip accumulator 5 ensures a compensation and/or an adjustment of different movement speeds of the steel sheet 2 between the preparation station 4 and subsequent processing stations.

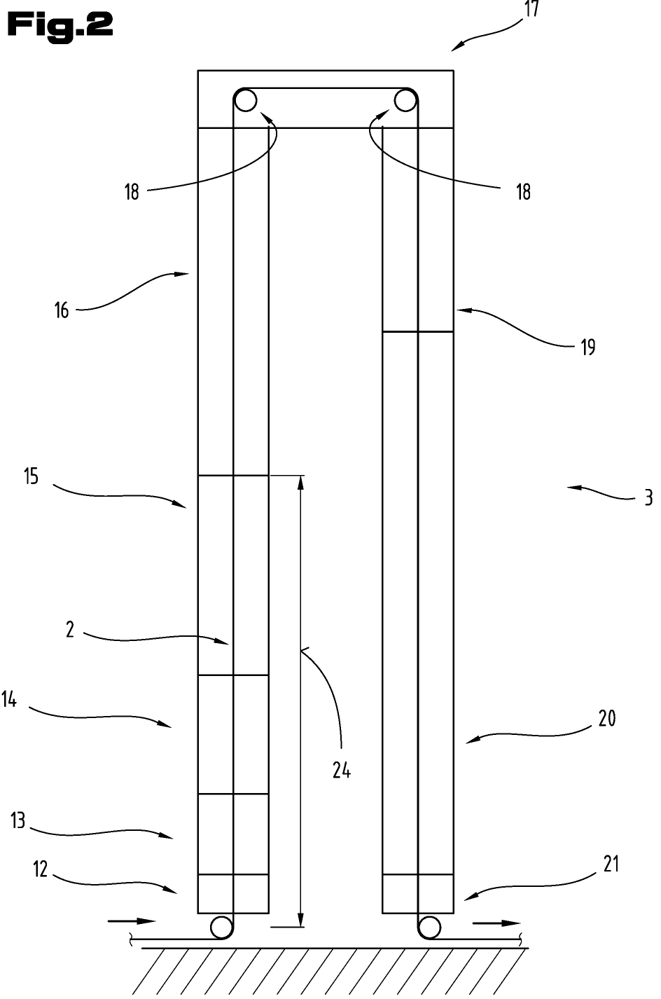

The cold-rolled steel sheet 2 is subsequently subjected to a heat treatment in the annealing plant 3, wherein the steel sheet 2 is moved in a vertical conveying direction in the annealing plant 3 - as will be described below with the aid of the images in FIG. 2. The heat treatment of the steel sheet 2 in the annealing plant 3 changes its crystalline structure such that an improvement of the magnetic properties of the finally obtained electric steel strip is achieved. By means of the vertical conveying direction of the steel sheet 2 during this heat treatment, contacts and/or a rolling of otherwise required conveying rollers on the steel sheet 2 can be avoided, in particular at high temperatures of the steel sheet 2, whereby these electric steel strips obtain a high degree of uniformity of their surfaces. In order to influence its crystalline structure, the steel sheet 2 passes through a heating region, a holding region and a cooling region during the heat treatment in the annealing plant 3, each of the regions having a separate, adapted temporal temperature progression.

For controlling the processing method in the device 1, it comprises a control device 6, by means of which both the temperatures in the mentioned regions of the annealing plant 3 and the movement speed of the steel sheet 2 are controlled to achieve the relevant temporal temperature progressions. The control of the processing method in the device 1 is additionally based on information from subsequent checking devices for monitoring the obtained quality of the steel sheet 2. Thus, after leaving the annealing plant 3, the steel sheet 2 passes through a measuring station 7, in which the magnetic properties of the steel sheet 2 after the heat treatment are detected. In case of deviations from the desired properties of the steel sheet 2, it is hence possible to automatically influence the processing method - in particular in the annealing plant 3 - in a correcting manner by means of the control device 6. Apart from detecting the magnetic properties of the steel sheet 2 in the measuring station 7, it may also be equipped for measuring other properties, such as geometric dimensions of the processed steel sheet 2.

In a preferred embodiment, the device 1 for carrying out the processing method subsequently also comprises a coating station 8 for applying and for subsequently drying a protective coating on the steel sheet 2. In further consequence, a coating measuring station 9 is provided, in which the thickness and uniformity of the protective coating applied to the steel sheet 2 is measured and hence checked. Finally, a further strip accumulator 10 and, following it, a post-processing station 11 are provided at the exit side. The latter primarily serves to cut the steel sheet 2 passing through the device 1 as an endless belt into partial strips and winding them up onto individual coils.

As a detail of FIG. 1, FIG. 2 shows the annealing plant 3 in a simplified schematic diagram of its components. This plant for heat treating the steel sheet 2 comprises, in order of the movement direction of the steel sheet 2, a furnace entry region 12, a rapid heating region 13 and a vertical furnace 14. A holding region and/or a holding zone 15 adjoins the vertical furnace 14 in its uppermost end region. Further in the ascending strand of the steel sheet 2, a first cooling zone 16 follows and in an upper end region of the annealing plant 3, a deflection region 17 follows. This has deflection rollers 18, over which the steel sheet 2 is guided and is thus transferred from the ascending strand into the descending strand of the annealing plant 3. Following the deflection region 17 arranged in the upper end region of the annealing plant 3 is a second cooling zone 19, a third cooling zone 20 and lastly, a furnace exit region 21.

During its heat treatment, the steel sheet 2 is moved in the annealing plant 3 in an inert gas atmosphere consisting mainly of hydrogen. The inert gas atmosphere contains hydrogen with a proportion of more than 99 %. As the steel sheet 2 is continuously moved through the inside of the annealing plant 3 in a continuous process, it is particularly important that the transitions of the steel sheet 2 are formed to be as gas-tight as possible upon entering the furnace entry region 12 and exiting the annealing plant 3 through the furnace exit region 21. Accordingly, the furnace entry region 12 and the furnace exit region 21 each have particular gas seals. Optionally, it is also possible for seals to be provided between the rapid heating region 13 and the vertical furnace 14, and between the vertical furnace 14 and the first cooling zone 16. Moreover, it is provided for the inert gas atmosphere, which consists of more than 99 % hydrogen, in the annealing plant 3 to contain as few remainders of the water vapor as possible. Preferably, the inert gas atmosphere contains water vapor with a proportion corresponding with a dew point of -70° C. to -45° C. This inert gas atmosphere with more than 99 % of hydrogen and the particularly low water vapor content is maintained at least in the volume extending from the furnace entry region 12 via the heating region, the holding zone 15 and the deflecting region 17. In the following section, after the deflection region 17, it is also possible for an inert gas atmosphere of lower purity to be provided.

The rapid heating region 13 and the vertical furnace 14 together form the heating region of the annealing plant 3. After this, the holding region in the holding zone 15 and finally, the cooling region composed of the first cooling zone 16, the deflection region 17 and the second and the third cooling zone 19, 20 in the descending strand of the annealing plant 3 follow. Due to the thermal energy supplied to the steel sheet by the rapid heating region 13 and the vertical furnace 14 during its upwards movement, the steel sheet 2 is finally heated to a maximum temperature in a range of 920° C. to 1,150° C. In this process, the steel sheet 2 is simultaneously subjected to a tensile load corresponding to the self-weight of the steel sheet 2 suspended further down. The measurements of the rapid heating region 13, the vertical furnace 14 and the furnace entry region 12 are dimensioned in this regard such that a height 24 of a region of the steel sheet 2 with its maximum temperature is so large that the tensile stress present in the steel sheet 2 is less than 5 MPa. The height 24 is preferably selected such that the tensile stress is less than 4 MPa. The height 24 of the region with the maximum temperature in the annealing plant 3 corresponds to about half of the total height of the annealing plant 3.

In a preferred embodiment variant of the method, it is moreover provided that during the heat treatment in the annealing plant 3, periodically ebbing and flowing tensile stresses are introduced into the steel sheet 2 as an additional treatment. This can be achieved, for example, by generating torques of different magnitudes, which are applied to the conveying rollers for the movement of the steel sheet 2. However, in this regard, it is provided in any case that in cross-sections of the region of the steel sheet 2 with the maximum temperature, the respectively occurring tensile stress does not exceed a value of 5 MPa. The occurring tensile stress is preferably kept at one value, which is less than 4 MPa. Due to the treatment with such an alternating load during the heat treatment, the formation of good magnetic properties can additionally be promoted. In particular, this allows avoiding irregularities of the magnetic properties (magnetic anisotropy) during the annealing process in the longitudinal and transverse direction of the steel strip 2.

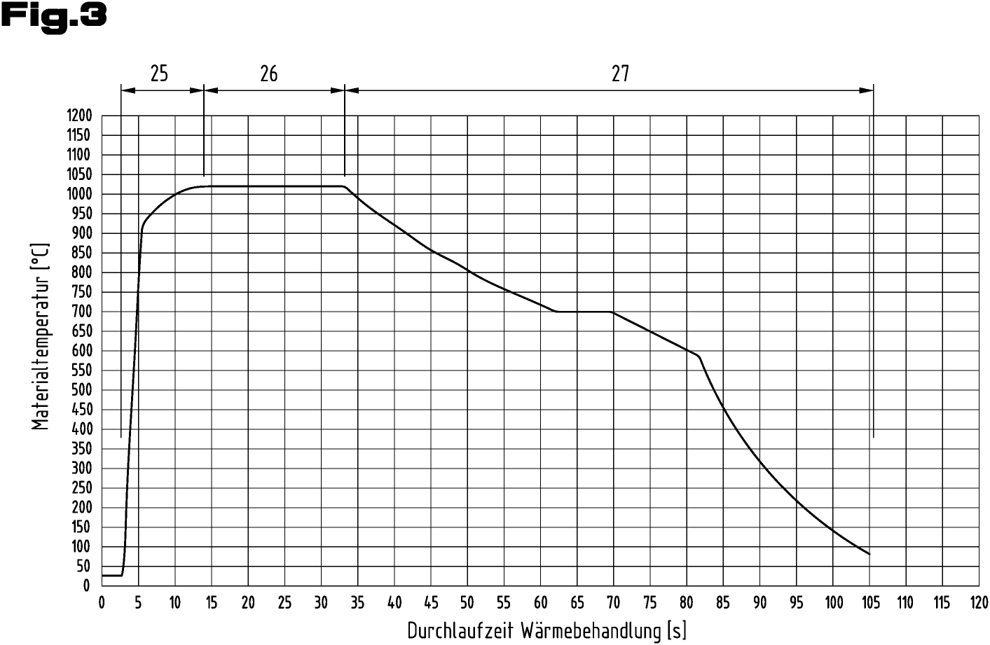

The heat treatment of the steel sheet 2 in the annealing plant 3 will be further elucidated below with reference to FIG. 3. FIG. 3 shows a diagram of the chronological sequence of the temperature of the steel sheet 2 during its heat treatment. In this regard, a distinction is to be made between a heating phase 25, a holding phase 26, and a cooling phase 27. At the beginning of the heating phase 25, a heating takes place having a steeply ascending temperature curve in the first section, at a heating rate of 100° C./s to 600° C./s. This rapid heating of the steel sheet 2 is achieved by the rapid heating region 13 (FIG. 2). Subsequently, the steel sheet is further heated to a maximum temperature in a second section, at a heating rate of 10° C./s to 50° C./s. This second part of the heating phase is effected in the vertical furnace 14. The heating of the steel sheet 2 preferably takes place up to a maximum temperature in a range of 950° C. to 1,100° C. In the holding region and/or the holding zone 15, the temperature is then kept at the maximum temperature for the duration of the holding phase 26. The length and/or duration of the holding phase 26 is in a range of 5 seconds to 45 seconds, preferably in a range of 10 seconds to 30 seconds.

At the end of the holding phase 26, the temperature of the steel sheet 2 then transitions into the cooling phase 27 - in accordance with the transition of the steel sheet 2 from the holding zone 25 into the first cooling zone 16. At the beginning of this cooling phase 27, the steel sheet 2 is first cooled down from the maximum temperature to a first intermediate temperature having a value in the range of 200° C. to 1100° C., preferably 400° C. to 900° C., in accordance with the movement of the steel sheet 2 in the first cooling zone 16 between the holding zone 15 and the deflection region 17. The cooling down to the first intermediate temperature is carried out comparatively slowly, at a cooling rate of 3° C./s to 20° C./s, preferably at a cooling rate of 5° C./s to 15° C./s. While the steel sheet 2 is guided over the deflection rollers 18, its temperature in the deflection region 17 is kept roughly constant at the first intermediate temperature. Subsequently to the deflection roller 18, after leaving the deflection region 7, the cooling is continued in the second cooling zone 19 until a second intermediate temperature in a range of 600° C. to 700° C. is reached. In this process, the speed of the cooling is carried out at a cooling rate of 3° C./s to 20° C./s, preferably at a cooling rate of 5° C./s to 15° C./s. In the last section of the cooling phase 27 - corresponding to the third cooling zone 20 with the movement of the steel sheet 2 towards the furnace exit region 21 -the steel sheet 2 is cooled down from the second intermediate temperature to approximately room temperature, wherein cooling is carried out at a cooling rate of 10° C./s to 50° C./s.

Regarding the temperature progression during cooling, i.e. during the transition from the maximum temperature via the first intermediate temperature in the deflection region 17 to the second intermediate temperature and eventually to the final cooling to room temperature, at least two different variants can be distinguished:

Example 1: After the holding region in the holding zone 15, the temperature of the steel sheet 2 is reduced to a value of the first intermediate temperature of about 800° C. in the first cooling zone 16. With this value of the first intermediate temperature, the steel sheet 2 is guided over the deflection rollers 18 in the deflection region 17, and subsequently, cooling is continued in the second cooling zone 19 at an initially lower cooling speed. In the second cooling zone 19, the temperature is reduced at a rate of about 10° C./s. Only when the steel sheet 2 has reached a value of the second intermediate temperature in a range of 600° C. to 700° C., the cooling is continued in the third cooling zone 20 at a cooling rate of typically 35° C./s.

Example 2: In this variant, a value of the first intermediate temperature of the steel sheet 2 of about 600° C. is already reached in the first cooling zone 16. After deflecting the steel sheet 2 in the deflection region 17 on the deflection rollers 18, the further cooling can then be continued at the high cooling rate of typically 35° C./s - in the course of the second cooling zone 19 as the third cooling zone 20.

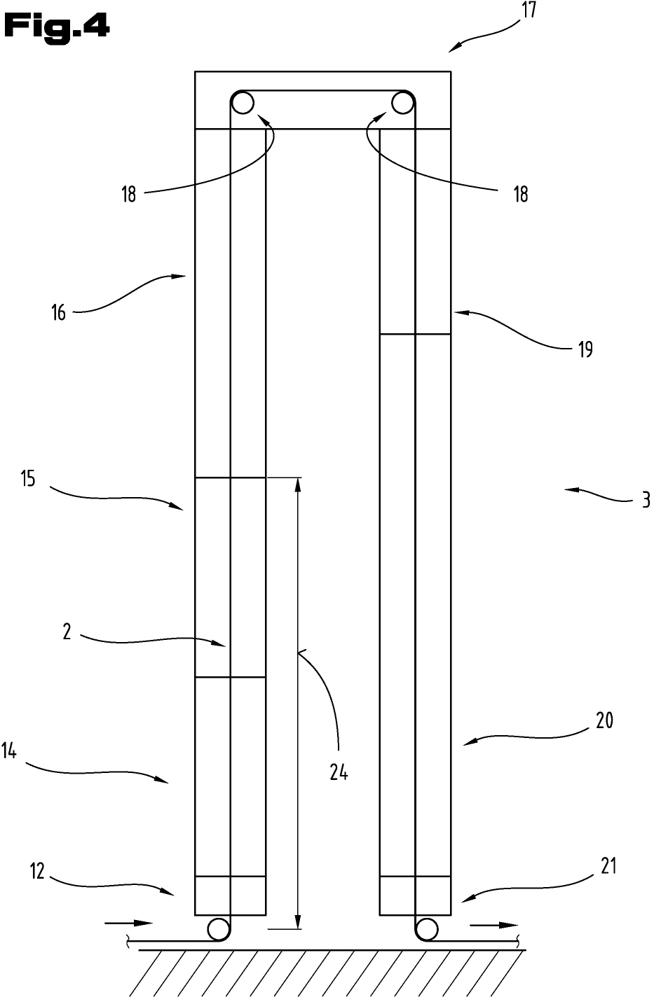

FIG. 4 shows an alternative exemplary embodiment of the annealing plant 3 for heat treatment of the steel sheet 2 according to FIG. 1. In this annealing plant 3, the vertical furnace 14 is provided directly adjoining the furnace entry region 12. This means that, in contrast to the embodiment according to the image in FIG. 2, no rapid heating region 13 is comprised, and the heating of the steel sheet 2 is carried out to the maximum temperature only by means of the vertical furnace 14. In this regard, the vertical furnace 14 may comprise a gas-powered or, preferably, an electric heating system. In this annealing plant 3, the heating of the steel sheet 2 is carried out at a heating rate between 5° C./s and 100° C./s.

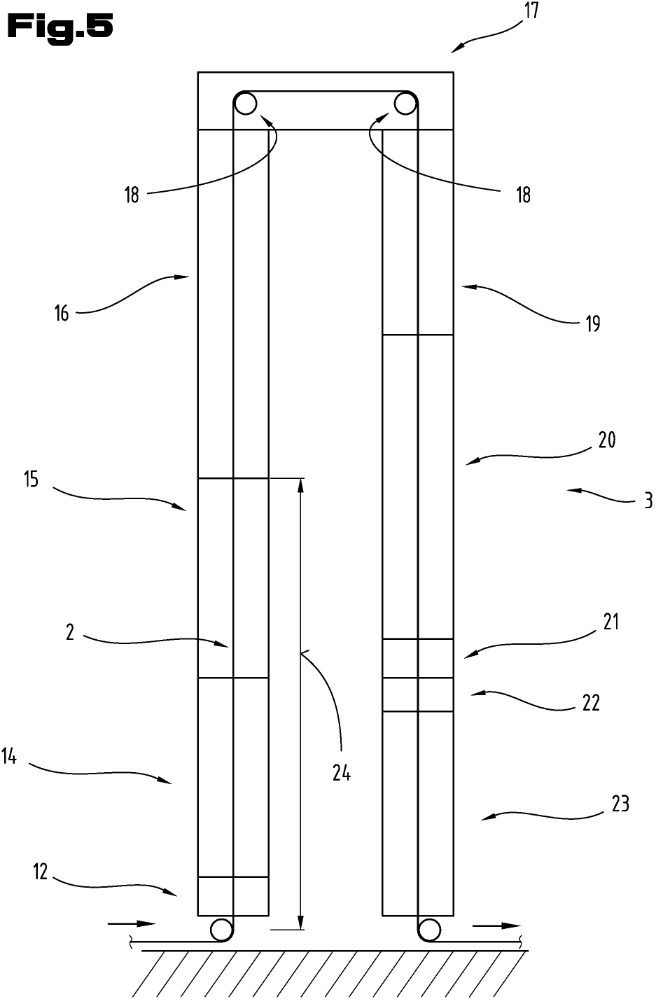

A further embodiment variant of an alternative annealing plant 3 is shown in FIG. 5 in a schematically simplified manner. Regarding the provided heating, this annealing plant 3 corresponds with the example according to FIG. 4 in so far as only the vertical furnace 14 is provided for heating, as well. After the third cooling zone 20, a coating station 8 in the descending strand follows in this exemplary embodiment (FIG. 1). Said station is designed for a vertical conveying direction of the steel sheet 2 and comprises a coating zone 22 and a drying zone 23. By integrating the coating station 8 into the descending strand of the annealing plant 3, overall, the advantage of a reduced space requirement in the complete plant is achieved.

The described method of processing the siliceous, cold-rolled steel sheet 2 with the heat treatment in the device 1 enables, in an advantageous manner, the production of a non-grain-oriented electric steel strip having a highly homogeneous crystalline structure, improved magnetic properties and a significantly improved surface quality. Applying this method is suitable in particular for treating electric steel strips made from alloyed steels with alloying components in weight proportions of Si: 1.5% to 6%, preferably 2% to 4%, Al: 0.05% to 2%, C: < 0.01%, preferably < 0.005%, Mn: 0.05% to 5%, P: 0.01% to 0.2%, S:<0.01%, preferably < 0.005%, and N: < 0.01%, preferably < 0.005%.

Due to the high H₂ concentration in the device 1 and/or the high dryness (the very low dew point) in the device 1 and/or the vertical concept (vertical conveying direction), the risk of an oxide buildup on the deflection roller can be avoided during the processing of the steel sheet 2, even with the high Si, A1, and Mn contents in the strip in combination with high deflection temperatures. Thereby, periodic strip impressions and thus plant downtime can be avoided. By means of higher deflection temperatures of the strip, the throughput of the device 1 can be increased.

An embodiment variant of the method may provide the following steps:
unwinding the strip (for the steel sheet 2)
welding the strip to a further strip to form an endless belt
cleaning and/or degreasing the strip
vertically guiding the strip during the annealing process in a device 1 with an upwards and a downwards region (for example with deflection temperatures of at least 200° C., in particular between 200° C. and 950° C., e.g. between 400° C. and 500° C., in the region of the upper deflection of the strip)
cooling the strip
possibly coating the strip
possibly drying the coating
winding the finished strip
The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

List of reference numbers

| | |
|---|---|
| 1 | Device |
| 2 | Steel sheet |
| 3 | Annealing plant |
| 4 | Preparation station |
| 5 | Strip accumulator |
| 6 | Controller |
| 7 | Measuring station |
| 8 | Coating station |
| 9 | Coating measuring station |
| 10 | Strip accumulator |
| 11 | Post-processing station |
| 12 | Furnace entry region |
| 13 | Rapid heating region |
| 14 | Vertical furnace |
| 15 | Holding zone |
| 16 | First cooling zone |
| 17 | Deflection region |
| 18 | Deflection roller |
| 19 | Second cooling zone |
| 20 | Third cooling zone |
| 21 | Furnace exit region |
| 22 | Coating zone |
| 23 | Drying zone |
| 24 | Height |
| 25 | Heating phase |
| 26 | Holding phase |
| 27 | Cooling phase |

1. A method for processing a siliceous, cold-rolled steel sheet, the method comprising:
providing the steel sheet in a strip-type state, the steel sheet including a part by weight of silicon of 1.5 % to 6 %;
conducting a heat treatment for producing a non-grain-oriented electric steel strip; and;
moving the steel sheet through an annealing plant with a heating region, a holding region and a cooling region in a continuous process during the heat treatment, the steel sheet is moved in the annealing plant in a vertical conveying direction;
wherein the steel sheet is moved in the annealing plant from a furnace entry region arranged in a lower end region of the annealing plant via deflection rollers arranged in an upper end region of the annealing plant to a furnace exit region arranged in the lower end region of the annealing plant;
the heating region and the holding region extend between the furnace entry region and the deflection rollers; and
in a cross-section of a region of the steel sheet with a maximum temperature, a tensile stress occurs, the value of which is less than 5 MPa.

2. (canceled)

3. (canceled)

4. The method according to claim 1, wherein during a heating phase, the steel sheet is heated in the heating region to a maximum temperature in a range of 920° C. to 1150° C.

5. The method according to claim 1, wherein the heating of the steel sheet is carried out during the heating phase at a heating rate of 5° C./s to 100° C./s.

6. The method according to claim 1, wherein the heating of the steel sheet is carried out during the heating phase at a heating rate of 100° C./s to 1000° C./s in a first section, and at a heating rate of 3° C./s to 50° C./s in a second section.

7. The method according to claim 1, wherein in the holding region, the steel sheet is held at the maximum temperature in a holding phase with a duration of 5 s to 45 s.

8. The method according to claim 1, wherein in the cross-section of the region of the steel sheet with the maximum temperature, a tensile stress occurs, the value of which is less than 4 MPa.

9. The method according to claim 1, wherein in the cross-sections of the steel sheet with the maximum temperature, the tensile stress is generated to ebb and flow over time.

10. The method according to claim 1, wherein following the holding phase, the steel sheet is cooled to a first intermediate temperature of 200° C. to 1100° C. between the holding region and the deflection rollers; and
the cooling is carried out at a cooling rate of 3° C./s to 20° C./s.

11. The method according to claim 10, wherein following the deflection rollers, the steel sheet is cooled down in a first section from the first intermediate temperature to a second intermediate temperature in a range of 600° C. to 700° C.; and
the cooling is carried out at a cooling rate of 3° C./s to 30° C./s.

12. The method according to claim 11, wherein subsequently, in a second section, the steel sheet is further cooled down from the second intermediate temperature during the movement towards the furnace exit region; and
the cooling is carried out at a cooling rate of 3° C./s to 60° C./s.

13. The method according to claim 1, wherein an inert gas atmosphere consisting mainly of hydrogen and having a hydrogen content of more than 99 % is provided in the annealing plant.

14. The method according to claim 13, wherein water vapor with a proportion corresponding with a dew point of -70° C. to -45° C. is contained in the inert gas atmosphere.

15. The method according to claim 1, wherein the steel sheet has a thickness of 0.1 mm to 0.5 mm.

16. The method according to claim 1, wherein after the heat treatment, a protective coating is applied to the steel sheet; and
the coating takes place during a movement in a vertical conveying direction.

17. The method according to claim 1, wherein the steel sheet contains alloying components in weight proportions Si: 1.5% to 6%, Al: 0.05% to 2%, C: < 0.01%, Mn: 0.05% to 5%, P: 0.01% to 0.2%, S: < 0.01%, and N: < 0.01%.

18. The method according to claim 1, wherein during a heating phase, the steel sheet is heated in the heating region to a maximum temperature in a range of 950° C. to 1100° C.

19. The method according to claim 1, wherein in the holding region, the steel sheet is held at the maximum temperature in a holding phase with a duration of 10 s to 30 s.

20. The method according to claim 1, wherein following the holding phase, the steel sheet is cooled to a first intermediate temperature of 400° C. to 900° C. between the holding region and the deflection rollers; and
the cooling is carried out at a cooling rate of 5° C./s to 15° C./s.

21. The method according to claim 20, wherein following the deflection rollers, the steel sheet is cooled down in a first section from the first intermediate temperature to a second intermediate temperature in a range of 600° C. to 700° C.; and
the cooling is carried out at a cooling rate of 5° C./s to 15° C./s.

22. The method according to claim 21, wherein subsequently, in a second section, the steel sheet is further cooled down from the second intermediate temperature during the movement towards the furnace exit region; and
the cooling is carried out at a cooling rate of 3° C./s to 35° C./s.
